(19) United States
(12) Patent Application Publication
(10) Pub. No.: US 2011/0000379 A1
(43) Pub. Date: Jan. 6, 2011

(54) HOT WATER BREWING MACHINE

(75) Inventor: Chih-hao CHEN, Taichung County (TW)

Correspondence Address: RABIN & Berdo, PC, 1101 14TH STREET, NW, SUITE 500, WASHINGTON, DC, 20005, US

(73) Assignee: Tsann Kuen (Zhangzhou) Enterprise Co., Ltd., Fujian Province (CN)

(21) Appl. No.: 12/830,598

(22) Filed: Jul. 6, 2010

(30) Foreign Application Priority Data
Jul. 6, 2009 (CN) 200920139416.6

(51) Int. Cl. A47J 31/00

(52) U.S. Cl. 99/323.3

(57) ABSTRACT

The present invention discloses a hot drink brewing machine, comprising a hot water supply mechanism, an ultrasonic extraction box, a leaching cup, an ultrasonic oscillator and a water effluent mechanic Said ultrasonic oscillator is connected to the ultrasonic extraction box for speeding up the extraction of the brewed object, thereby it not only acquires a quicker brewing process, but also acquires a more appropriate brewed favor.

### FIELD OF THE INVENTION

The present invention relates to a hot drink brewing machine, especially relates to an automatic hot drink brewing machine.

### BACKGROUND OF THE INVENTION

The hot drink is used to be brewed manually, for example as brewing the tea or coffee, it usually needs many tools and a complicated operation, thereby it will be inconvenient for the users. There is a solution for the above inconvenience of manual brewing, for example as Chinese application NO.ZL98203904.2 published in Chinese patent database. Said device comprises a container the bottom of which is disposed with a concave cavity and a mechanism for heating the concave cavity; a tea scoop disposed in the upper part of the container, which has a channel through to the bottom and a straight pipe whose opening is higher than the bottom of said tea scoop; a water pipe, whose lower end is connected to the concave cavity inside of the container and its upper end goes through the pipe inside of the tea scoop to communicate with the tea scoop, said water pipe can conduct the boiling water of the concave cavity flow out of its upper end by the boiling power; a cover disposed inside of the tea scoop, which is a sleeve body with an open end sleeved in the straight pipe, there is a continuous space between said cover and the straight pipe to form a siphon piping mechanism, so the brewed water of the bottom of the tea scoop can flow into the container of the lower part of the tea scoop through said siphon piping and the straight pipe. However, said device has such disadvantage: because the brewed object can not be driven into the hot water quickly, so the user has to wait for a long time, and it brings inconvenience to the user.

### SUMMARY OF THE INVENTION

The present invention provides a hot drink brewing machine, which overcome the disadvantage of the conventional brewing machine.

The technical solution applied by the present invention is:

Hot drink brewing machine, comprising:

a hot water supply mechanism for providing hot water;

an ultrasonic extraction box connected to said hot water supply mechanism for receiving the hot water provided by the hot water supply mechanism;

a leaching cup connected to the inside of said ultrasonic extraction box for containing brewed object;

an ultrasonic oscillator connected to said ultrasonic extraction box for accelerating the extraction speed of the brewed object; and

a water effluent mechanism connected to said ultrasonic extraction box for pouring out hot drink.

In a preferred embodiment, it further comprises:

a water level switch for controlling the on and off of the ultrasonic extraction box according to the hot water level inside of the ultrasonic extraction box, which is connected to said ultrasonic extraction box, and connected to the ultrasonic oscillator by signal.

In a preferred embodiment, said ultrasonic oscillator is connected to the bottom part of the ultrasonic extraction box.

In a preferred embodiment, said hot water supply mechanism comprises:

a water box;

a water filtering cup, which is under the water box;

a filter for filtering the water, which is connected between the water box and the water filtering cup;

a heating chamber for receiving the filtered water of the water leaching cup, which is under the water filtering cup;

a heater disposed in the heating chamber.

In a preferred embodiment, said hot water supply mechanism further comprises:

a siphon piping, whose first end is connected to the heating chamber and its second end is connected to the top part of the ultrasonic extraction box.

In a preferred embodiment, a fixing shelf is fixed inside said heating chamber and fixed to the heater.

In a preferred embodiment, said water effluent mechanism comprises:

a water effluent piping, which has a first end communicates with the ultrasonic extraction box;

a valve switch to be selected to close or open the water effluent piping; and

a controlling mechanism connected to the valve switch for controlling the valve switch.

In a preferred embodiment, said controlling mechanism comprises a press key and an operation mechanism connecting the press key and the valve switch.

Compared to the technique background: the ultrasonic oscillator is provided in the present brewing machine, it has mechanical effect, cavitation effect and pyrometric effect which will increase the movement velocity of molecule, the penetrating power of the molecule can extract the effective ingredient of the organism, so the extraction speed of the brewed object will be quicker and the effect is better, thereby the disadvantage of the background technique will be overcome, it will not only increase the brewing speed, but also acquire an appropriate favor in the present invention. The water level controls the ultrasonic oscillator, so the extraction of the brewed object will be controlled with a better effect, meanwhile the ultrasonic oscillator will be protected. The filter can filter the water to provide a cleaner drinking water. The siphon piping sucks the hot water to the ultrasonic extraction box from the heating chamber, so the structure of the brewing machine will be impact and space-saving.

### BRIEF DESCRIPTION OF THE DRAWINGS

The present invention will become apparent with the reference of the accompanying drawings and the embodiments.

FIG. 1 is the sectional structural view of the hot drink brewing machine of the present invention.

FIG. 2 is the perspective view of the hot drink brewing machine of the present invention.

FIG. 3 is the exploded perspective view of the hot drink brewing machine of the present invention.

### DETAILED DESCRIPTION OF THE EMBODIMENTS

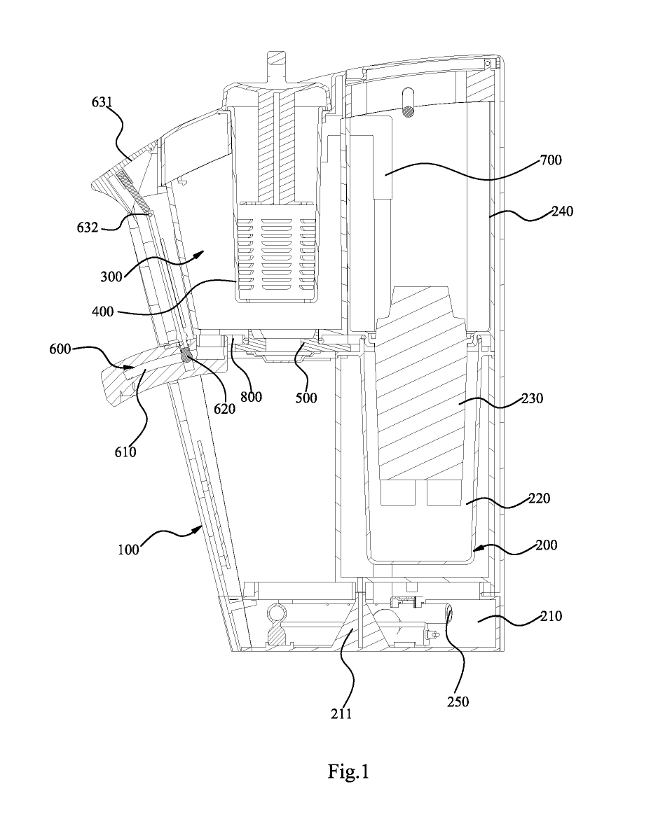

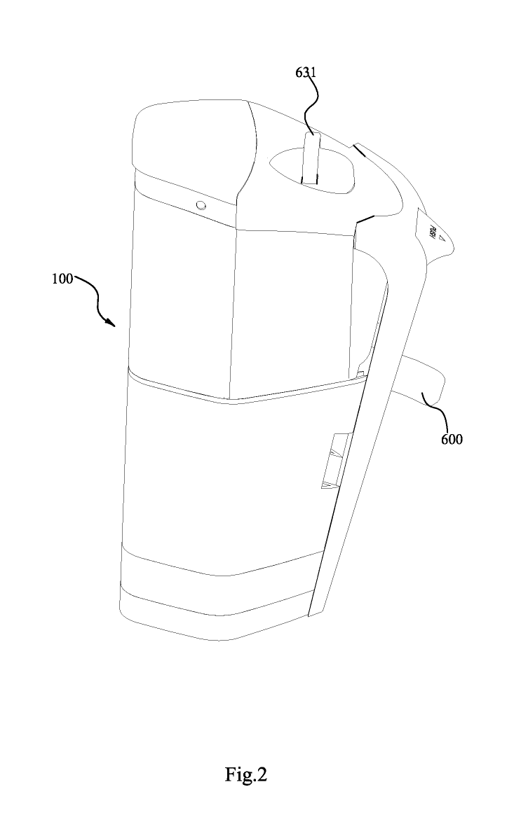

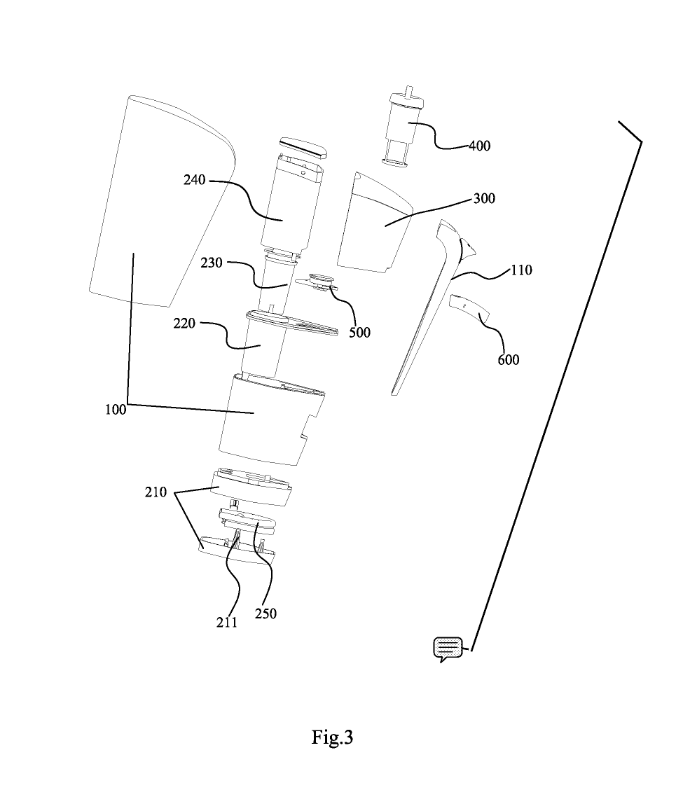

Please refer to FIG. 1, FIG. 2 and FIG. 3, a hot drink brewing machine comprises a housing 100, a hot water supply mechanism 200 is disposed inside of said housing 100 for providing hot water, an ultrasonic extraction box 300 which can receive hot water provided by the hot water supply mechanism 200, a leaching cup 400 which can contain the brewed object, an ultrasonic oscillator 500 which can accelerate the extraction speed of the brewed object and the water effluent mechanism 600 which can effluent hot drink. Said housing 100 is provided with a front decoration board 110.

Said hot water supply mechanism 200 comprises a heating chamber 210, a water filtering cup 220, a filter 230, a water box 240 and a heater 250. Said heating chamber 210 is located in the bottom of the inner chamber of the housing 100, further, the inside of said heating chamber 210 is provided with a fixing shelf 211, said fixing shelf 211 is fixed to the heater 250, the heater 250 can be an electric heater for heating the filtered water inside of said heating chamber 210. Said water filtering cup 220 is disposed above the heating chamber 210 and located in the right middle part of the housing 100; said water box 240 is detachably connected to the housing 100 and located above the water filtering cup 220 and in the right upper part of the housing 100. Said filter 230 is connected between the water box 240 and the water filtering cup 220. The water inside of said water box 240 flows into the water filtering cup 220 through the filter 230, then the filtered water inside of said water filtering cup 220 will flow into the heating chamber 210.

Said ultrasonic extraction box 300 is disposed inside of the housing and located in its left upper part. Further equipped with a siphon piping 700, whose lower end is connected to the heating chamber 210 and its upper end is connected to the top part of the ultrasonic extraction box 300, said siphon piping 700 is used for sucking or pushing (by the steam force) the hot water inside of the heating chamber 210 to the ultrasonic extraction box 300. A pump is disposed according to the practical requirement, which pumps the hot water inside of the heating chamber to the ultrasonic extraction box 300. Moreover, a water level switch 800 is disposed on said ultrasonic extraction box 300 and connected to the ultrasonic oscillator 500 by signal, which can control the on and off of the ultrasonic oscillator 500 according to the hot water level inside of the ultrasonic extraction box 300.

Said leaching cup 400 can be detachably hanged inside of the ultrasonic extraction box 300, moreover, the bottom of said leaching cup 400 is spaced from the bottom wall of the ultrasonic extraction box 300. In the present invention, the structure of said leaching cup 400 can be a cup, the peripheral wall of said cup has a plurality of holes communicate through the inside and the outside.

Said ultrasonic oscillator 500 is disposed under the ultrasonic extraction box 300. Wherein, said ultrasonic oscillator 500 is an existing technique and need not further description.

Said water effluent mechanism 600 comprises a water effluent piping 610, a control mechanism and a valve switch 620 to be selected to closer or open the water effluent piping 610. The first end of said water effluent piping 610 is connected to the bottom part of the ultrasonic extraction box 300, its second end goes through to the outside of the housing for pouring out the hot drink. Said valve switch 620 is a silica gel ball. Said control mechanism comprises a press key 631 disposed in the bottom part of the housing and an operation mechanism 632 connecting the press key 631 and the valve switch 320. After the user presses the press key 631, the operation mechanism 632 will act to drive the silica gel ball to move, so the water effluent piping 610 will be in open status, when the user stops pressing the press key, the operation mechanism 632 will back to its original position to drive the silica gel ball move to its original position, so the water effluent piping will be in closed status. The operation mechanism 632 can apply an existing technique, for example as the operation mechanism used on the coffee machine.

The working process of said brewing machine comprises: the water contained in the water box 240 is filtered with the filter 230 and then flows into the water filtering cup 220, the water of the water filtering cup 220 flows into the heating chamber 210, the heater 250 heats the filtered water of said heating chamber 210; the water is heated between 40 to 100 centigrade and then flows into the ultrasonic extraction box 300; when the water level of the ultrasonic extraction box 300 is raised to a certain height, the water level switch 800 controls the ultrasonic oscillator 500 to work, and the brewed object in the leaching cup 400 is extracted gradually to be hot drink. When the user presses the press key 631 continuously, he will acquire the brewed hot drink

Although the present invention has been described with reference to the preferred embodiments thereof for carrying out the invention, it is apparent to those skilled in the art that a variety of modifications and changes may be made without departing from the scope of the present invention which is intended to be defined by the appended claims.

What is claimed is:

1. Hot drink brewing machine, wherein it comprises:
a hot water supply mechanism for providing hot water;
an ultrasonic extraction box connected to said hot water supply mechanism for receiving the hot water provided by the hot water supply mechanism;
a leaching cup connected to the inside of said ultrasonic extraction box for containing brewed object;
an ultrasonic oscillator connected to said ultrasonic extraction box for accelerating the extraction speed of the brewed object; and
a water effluent mechanism connected to said ultrasonic extraction box for pouring out hot drink.

2. The hot drink brewing machine according to claim 1, wherein it further comprises:
a water level switch for controlling the on and off of the ultrasonic extraction box according to the hot water level inside of the ultrasonic extraction box, which is connected to said ultrasonic extraction box, and connected to the ultrasonic oscillator by signal.

3. The hot drink brewing machine according to claim 1, wherein said ultrasonic oscillator is connected to the bottom part of the ultrasonic extraction box.

4. The hot drink brewing machine according to claim 1, wherein said hot water supply mechanism comprises:
a water box;
a water filtering cup, which is under the water box;
a filter for filtering the water, which is connected between the water box and the water filtering cup;
a heating chamber for receiving the filtered water of the water filtering cup, which is under the water filtering cup;
a heater disposed in the heating chamber.

5. The hot drink brewing machine according to claim 4, wherein said hot water supply mechanism further comprises:
a siphon piping, whose first end is connected to the heating chamber and its second end is connected to the top part of the ultrasonic extraction box.

6. The hot drink brewing machine according to claim 5, wherein a fixing shelf is fixed inside said heating chamber and fixed to the heater.

7. The hot drink brewing machine according to claim 1, wherein said water effluent mechanism comprises:
a water effluent piping, which has a first end communicates with the ultrasonic extraction box;
a valve switch to be selected to close or open the water effluent piping; and
a controlling mechanism connected to the valve switch for controlling the valve switch.

8. The hot drink brewing machine according to claim 7, wherein said controlling mechanism comprises a press key and an operation mechanism connecting the press key and the valve switch.

9. The hot drink brewing machine according to claim 2, wherein said hot water supply mechanism comprises:
a water box;
a water filtering cup, which is under the water box;
a filter for filtering the water, which is connected between the water box and the water filtering cup;
a heating chamber for receiving the filtered water of the water filtering cup, which is under the water filtering cup;
a heater disposed in the heating chamber.

10. The hot drink brewing machine according to claim 3, wherein said hot water supply mechanism comprises:
a water box;
a water filtering cup, which is under the water box;
a filter for filtering the water, which is connected between the water box and the water filtering cup;
a heating chamber for receiving the filtered water of the water filtering cup, which is under the water filtering cup;
a heater disposed in the heating chamber.

11. The hot drink brewing machine according to claim 9, wherein said hot water supply mechanism further comprises:
a siphon piping, whose first end is connected to the heating chamber and its second end is connected to the top part of the ultrasonic extraction box.

12. The hot drink brewing machine according to claim 10, wherein said hot water supply mechanism further comprises:
a siphon piping, whose first end is connected to the heating chamber and its second end is connected to the top part of the ultrasonic extraction box.

13. The hot drink brewing machine according to claim 11, wherein a fixing shelf is fixed inside said heating chamber and fixed to the heater.

14. The hot drink brewing machine according to claim 12, wherein a fixing shelf is fixed inside said heating chamber and fixed to the heater.

15. The hot drink brewing machine according to claim 2, wherein said water effluent mechanism comprises:
a water effluent piping, which has a first end communicates with the ultrasonic extraction box;
a valve switch to be selected to close or open the water effluent piping; and
a controlling mechanism connected to the valve switch for controlling the valve switch.

16. The hot drink brewing machine according to claim 3, wherein said water effluent mechanism comprises:
a water effluent piping, which has a first end communicates with the ultrasonic extraction box;
a valve switch to be selected to close or open the water effluent piping; and
a controlling mechanism connected to the valve switch for controlling the valve switch.

17. The hot drink brewing machine according to claim 15, wherein said controlling mechanism comprises a press key and an operation mechanism connecting the press key and the valve switch.

18. The hot drink brewing machine according to claim 16, wherein said controlling mechanism comprises a press key and an operation mechanism connecting the press key and the valve switch.
